(19) United States
(12) Patent Application Publication
(10) Pub. No.: US 2023/0228136 A1
(43) Pub. Date: Jul. 20, 2023

(54) DOORSTOP

(71) Applicants: Jamie Prodehl, Minooka, IL (US); Ben Price, Oswego, IL (US)

(72) Inventors: Jamie Prodehl, Minooka, IL (US); Ben Price, Oswego, IL (US)

(21) Appl. No.: 18/099,043

(22) Filed: Jan. 19, 2023

Related U.S. Application Data
(60) Provisional application No. 63/301,097, filed on Jan. 20, 2022.

(51) Int. Cl. E05C 17/54

(52) U.S. Cl. CPC E05C 17/54

(57) ABSTRACT

A security doorstop has a base and a jaw pivotally connected to the base. A first end of the jaw has upwardly pointing teeth adapted to drive or press into an underside of a door, while the base has downwardly pointing teeth adapted to drive or press into a floor surface under the door underside. The actuator includes a screw and a threaded collar mounted on the screw so that, when the threaded collar is turned to be driven downward, operates to press downwardly on a proximal portion of the jaw so as to pivot a distal portion of the jaw upward, to press the jaw teeth upward against the door underside and the base teeth against the floor.

### CROSS-REFERENCE

This application claims the priority benefit of U.S. Provisional Application No. 63/301,097, filed on Jan. 20, 2022, entitled “DOORSTOP,” which is hereby incorporated by reference herein in its entirety.

### FIELD OF THE DISCLOSURE

The present disclosure relates to security doorstops. More particularly, it relates to security doorstops that engage the underside of a door.

### SUMMARY

According to an aspect of the present disclosure, a security doorstop comprises a base, a jaw, and an actuator. The base has a lower side with a downward facing floor gripping region. The jaw is pivotally connected to the base and has an upward facing door gripping region above the downward facing floor gripping region. The actuator is connected between the base and the jaw so that, when the door gripping region and the floor gripping region are positioned in a vertical gap between an underside of a door and a floor surface, actuating the actuator causes the door gripping region of the jaw to pivot upwardly relative to the floor gripping region of the base, to cause the door gripping region to press upwardly against the door underside and the floor gripping region to press downwardly against the floor surface.

### BRIEF DESCRIPTION OF THE DRAWINGS

Although the characteristic features of this disclosure will be particularly pointed out in the claims, the disclosed method and system, and how it may be made and used, may be better understood by referring to the following description taken in connection with the accompanying drawings forming a part hereof, wherein like reference numerals refer to like parts throughout the several views and in which:

FIG. 1 is a perspective view of a doorstop according to an embodiment.

FIG. 2 is an exploded perspective view of the doorstop of FIG. 1.

FIG. 3 is a top plan view of the doorstop of FIG. 1.

FIG. 4 is an exploded perspective view of a base and jaw of the doorstop of FIG. 1.

FIG. 5 is an exploded side elevation view of the base and jaw of FIG. 4.

FIG. 6 is a truncated perspective view of the doorstop of FIG. 1 in use according to an embodiment.

FIG. 7 is a perspective view of a doorstop according to another embodiment.

FIG. 8 is an exploded top-front/distal-left perspective view of a doorstop according to another embodiment.

FIG. 9 is a top-proximal/rear-left perspective view of the doorstop of FIG. 8 in use according to a method of another embodiment.

FIG. 10 is a left side elevation view of the doorstop of FIG. 8 with a fully lowered jaw.

FIG. 11 is a left side elevation view of the doorstop of FIG. 8 with a fully raised jaw.

A person of ordinary skill in the art will appreciate that elements of the figures above are illustrated for simplicity and clarity and are not necessarily drawn to scale. The dimensions of some elements in the figures may have been exaggerated relative to other elements to help to understand the present teachings. Furthermore, a particular order in which certain elements, parts, components, modules, steps, actions, events and/or processes are described or illustrated may not be required. A person of ordinary skill in the art will appreciate that, for simplicity and clarity of illustration, some commonly known and well-understood elements that are useful and/or necessary in a commercially feasible embodiment may not be depicted to provide a clear view of various embodiments per the present teachings.

### DETAILED DESCRIPTION

In the following description of various examples of embodiments of the disclosed system and method, reference is made to the accompanying drawings, which form a part hereof, and in which are shown by way of illustration various example devices, systems, and environments in which aspects of the disclosed system and method can be practiced. Other specific arrangements of parts, example devices, systems, and environments, can be used, and structural modifications and functional modifications can be made without departing from the scope of the disclosed system and method.

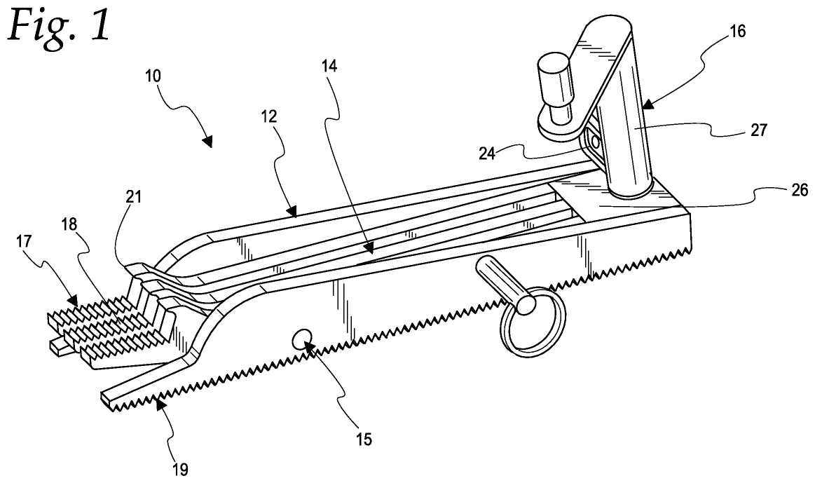

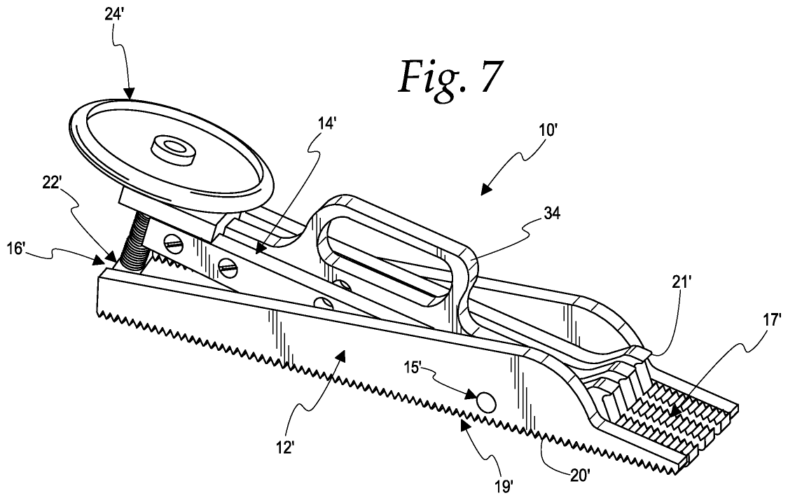

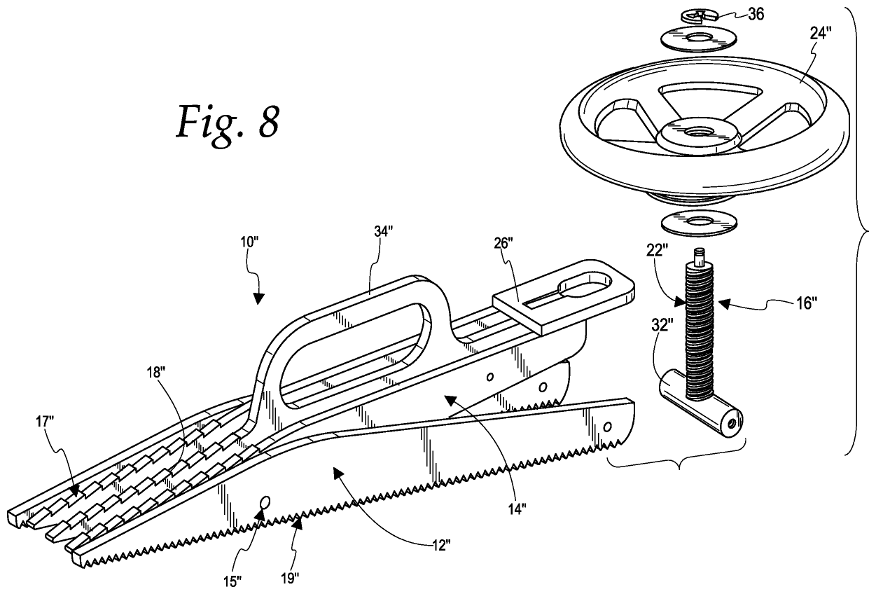

Described in the present disclosure and illustrated in the accompanying drawing figures are embodiments of a mechanical security doorstop that can be manually actuated to brace and release a door. The doorstop has a base, a jaw pivotally connected to the base, and a bi-directional manual actuator adapted to pivot the jaw to a selected angle relative to the base and to hold the jaw at the selected angle. The jaw has a door gripping region, and the base has a floor gripping region, at least a portion of the door gripping region being above at least a portion of the floor gripping region during normal use of the doorstop. When the door gripping region of the jaw and the floor gripping region of the base are inserted into a vertical gap between a door underside and a floor surface, actuating the manual actuator in a tightening direction causes the door gripping region to press upwardly against an underside of the door and the floor gripping region to press downwardly against the floor surface, to brace and hold the door closed against an opening force or torque applied to the door in a plane parallel to the floor surface. With reference to the drawing figures, a first embodiment of a doorstop 10 is illustrated in FIGS. 1-6, a second embodiment of a doorstop 10′ is illustrated in FIG. 7, and a third embodiment of a doorstop 10″ is illustrated in FIGS. 8-11.

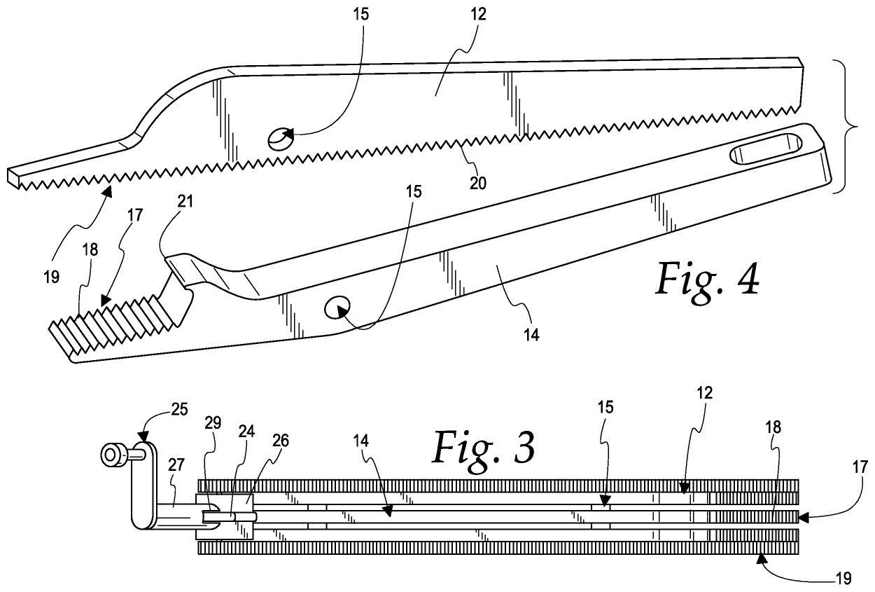

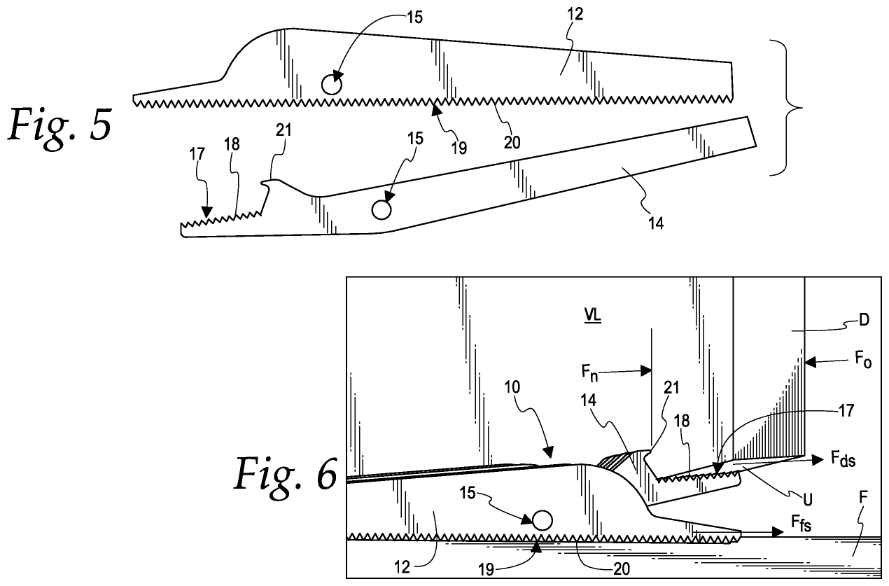

Turning to FIGS. 1-6, the doorstop 10 comprises a base 12, a jaw 14, and an actuator 16. The jaw 14 is pivotally connected to the base 12 at a pivotal joint 15, the pivotal joint 15 comprising a pin (best seen in the top view of FIG. 3) extending through respective holes in the base 12 and jaw 14, best seen in the exploded perspective and elevation views of portions of the base 12 and jaw 14 in FIGS. 4 and 5. The jaw 14 includes a door gripping region 17 at a distal end of the jaw 14, the door gripping region 17 comprising upward facing jaw teeth 18. The base 12 includes a floor gripping region 19 at a distal end of the base 12, the floor gripping region 19 comprising downward facing base teeth 20. The floor gripping region 19 may comprise all or only a portion of a lower side of the base 12 that is adapted to be supported on a floor surface, and thus the base teeth 20 may be distributed only along a distal portion of the lower side of the base 12 that is adapted to lie directly beneath a door underside, or the base teeth 20 may be distributed along an entire length of the lower side of the base 12, as shown in FIG. 4.

In embodiments according to this disclosure, including in the first and second illustrated embodiments of the doorstops 10 and 10′, of FIGS. 1-6 and FIG. 7, respectively, a jaw further includes a normal obstruction. In particular, the doorstops 10, 10′ include a normal obstruction 21, 21′ of the respective jaw 14, 14′. The normal obstruction 21, 21′ comprises an upward protrusion disposed proximally of the door gripping region 17, 17′, and more particularly a plurality of such upward protrusions. As illustrated in FIG. 6, the normal obstruction 21 is adapted to extend above an underside U of a door D that is gripped by the door gripping region 17, so as to oppose a vertical leading side VL of the door D that extends upwardly from a leading edge of the door underside U, so as to be operative to normally obstruct door-opening movement of the vertical leading side VL of the door D.

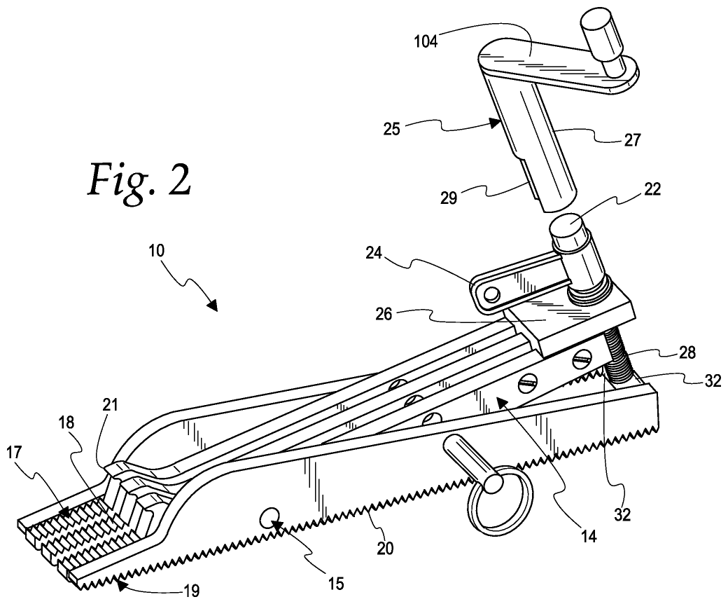

As seen in FIG. 2, the actuator 16 includes a screw 22 having a tabbed threaded collar 24 connected thereto such that, when the threaded collar 24 is driven downward on the screw 22, the threaded collar 24 pushes downwardly on a guide plate 26 that is affixed to the proximal end of the jaw 14, so as to cause the distal end of the jaw 14 to pivot upwardly so that the door gripping region 17 movies upwardly. The threaded collar 24 comprises a tab that extends transversely away from an axis of the screw 22, so as to provide leverage for manually turning the collar 24 about the screw 22. The threaded collar 24 may be turned directly by hand and is optionally driven by a removable hand crank 25, the crank 25 comprising a hollow crank shaft 27 with a notch 29 formed therein to receive and drive the threaded collar 24 as the hand crank 25 is rotated. An upper end of the screw 22 is inserted through the guide plate 26 with clearance to permit the guide plate 26 to travel up and down and to pivot relative to the screw 22, so as to accommodate pivotal movement of the jaw 14 relative to the base 12.

A lower end of the screw 22 is connected to the base 12 by mounting arms 32. Optionally, the mounting arms 32 are rotatably connected to the base 12 to permit the screw 22 to pivot relative to the base 12 and remain perpendicular to the guide plate 26, as the jaw 14 pivots up and down, so that the threaded collar 24 can be aligned so as to press perpendicularly against the guide plate 26 to force the proximal end of the jaw 14 to pivot downwardly. Alternatively or in addition, the guide plate 26 can have a longitudinal slot (not shown) that is operative to receive the screw 22 with sufficient longitudinal clearance to permit the jaw 14 to pivot throughout its operating range of motion without impinging on the screw 22 while the screw 22 remains upright. In embodiments in which an actuator screw is affixed to the base, the threaded collar can optionally have an annular rounded/radiused contact shoulder at its lower end for normally engaging a guide plate over a range of non-horizontal angles of inclination of the guide plate.

According to a method illustrated in FIG. 6, at least a portion of each of the door gripping region 17 of the jaw 14 and the floor gripping region 19 of the base 12 is inserted into a vertical gap between a door D and a floor surface F, and the actuator 16 is actuated so as to press the door gripping region 17 against an underside of the door D and the floor gripping region 19 against the floor surface F. When the doorstop 10 is disposed in this manner, an opening force Fₒ applied to the door D is resisted by a floor shear holding force F_{fs} between the floor surface and the floor gripping region 19, transmitted to the door as a door shear holding force F_{ds} between the underside of the door D and the door gripping region 17, and/or as a normal contact holding force Fₙ between the normal obstruction 21 and an opposing vertical side of the door D. The normal obstruction 21 serves to prevent the door D from being dislodged from the door gripping region 17 by a door opening force Fₒ exceeding the door shear holding force F_{ds}. Instead, such a force Fₒ applied to the door D could only permit entry if either sufficient to destroy the door D (such as by driving the normal obstruction 21 through an entire lower end thickness of the door D), or sufficient to overcome the floor shear holding force F_{fs} and maintained throughout an entire door opening movement required to open the door D wide enough to permit entry, while pushing the entire doorstop 10 across the floor surface F.

Turning to FIG. 7, analogous parts of the second embodiment of a doorstop 10′ to those of the doorstop 10 are labeled with like numerals followed by a “prime” symbol, for example, a base 12′, a jaw 14′, etc. A threaded collar of the doorstop 10′ is comprised in a hub of a one-piece handwheel 24′, the handwheel 24′ having a peripheral ring that fully encircles an axis of a screw 22′, to facilitate steady manual turning of the threaded collar on the screw 22′. The handwheel 24′ may be turned using either one hand or two hands, which may be placed on opposite sides of the handwheel 24′. In addition, the doorstop 10′ comprises a handle 34. The handle 34 is affixed to the jaw 14′ and facilitates sliding the doorstop 10′ into or out of position for securing a door, as well as carrying the doorstop 10′, by grasping the handle 34.

Turning to FIGS. 8-11, analogous parts of the third embodiment of a doorstop 10″ to those of the doorstop 10 and/or those of the doorstop 10′ are labeled with like numerals followed by a “double-prime” symbol, for example, a base 12″, a jaw 14″, etc. Similarly to the doorstop 10′, a threaded collar of the doorstop 10″ is comprised in a hub of a one-piece handwheel 24″, the handwheel 24″ having a different shape than that of the handwheel 24′, including integrally formed spokes extending from the hub/threaded collar of the handwheel 24″ to its outer ring. A removable c-clip 36 is operative to snap radially onto an upper end of a screw 22″ to retain the handwheel 24″ to the screw 22″. With reference to FIGS. 8, 10 and 11, a longitudinal slot formed in the guide plate 26″, in conjunction with the screw 22″ being pivotally mounted at its lower end to the base 12″, permits the screw 22″ to passively self-align perpendicularly to the guide plate 26″ as the handwheel 24″ is driven toward its bottommost position, at which the guide plate 26″ is sandwiched between the lower end of a threaded collar of the handwheel 24″ and the mounting arms 32″ of the screw 22″ (and optionally a washer, unlabeled in FIGS. 8-11, is sandwiched between the handwheel 24″ and guide plate 26″ as illustrated in FIG. 11).

The base 12″ is divided into substantially mirror-image left-side and right-side vertical plates, and the jaw 14″ comprises three vertical plates that are spaced evenly between the vertical plates of the base 12″, the three plates of the jaw 14″ being pivotally connected to the two plates of the base 12″ at the pivotal joint 15″. In addition, the three plates of the jaw 14″ are fixedly connected to one another and each to the guide plate 26″, and the two plates of the base 12″ are further connected to each other by each being pivotally connected to a respective lateral end of a pivotal base segment of the screw 22″. Similarly to the doorstop 10′, the middle plate of the jaw 14″ has a handle 34″ formed thereon for lifting and repositioning the doorstop 10″.

The base 12″ of the doorstop 10″ has formed at or near its distal end a top-surface ramp portion 37 that is inclined upwardly in a proximal direction. More particularly, the ramp portion 37 has a uniform incline generally extending alongside the length L of a door-gripping region 17″ of the jaw 14″, which can, for example, be about four to six inches, or more particularly approximately 5.14 inches, at an angle of inclination of about 10-20°, or more particularly approximately 15°.

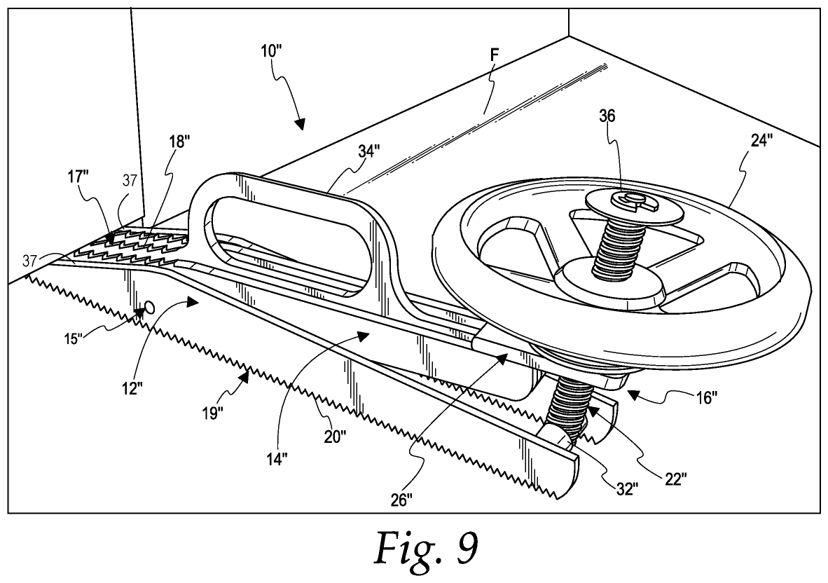

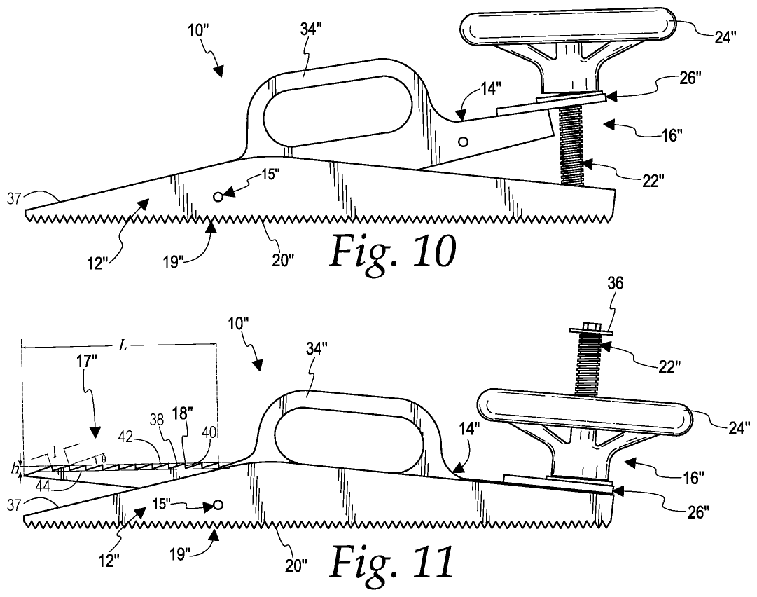

As shown in FIG. 11, each tooth 18″ of the door-gripping region 17″ has a distal face 38 and a proximal face 40, the teeth 18″ collectively defining a point line 42 that connects their tips and a base line 44 that connects the inside corners of the gaps between them, the base line 44 being parallel to the point line 42, and each being generally parallel to the ramp portion 34 of the base 12″ when the jaw 14″ is in a fully lowered position illustrated in FIG. 10. When the jaw is raised to the fully raised position shown in FIG. 11, the point line 42 and base line 44 are approximately parallel to the floor gripping region 19″ of the base 12″, and thus to a floor surface F (FIG. 9) when the base 12″ is supported thereon.

The distal face 38 of each tooth 18″ is inclined at an upward angle θ in the proximal direction of about 10-20° above the point line 42 and base line 44, or more particularly about 15°, thus approximately 30° above a bottom side of the jaw 14″, the bottom side of the fully lowered jaw 14″ being parallel to the floor gripping region 19″ and thus also to the floor F when the base 12″ is supported thereon. Accordingly, the distal tooth face 38 (and a distal end face of the jaw 14″ itself, which comprises that of the distalmost tooth 18″ and a forward/distal extension of it), can be inclined proximally approximately above a horizontal plane by an angle as large as about 30°, when the jaw 14″ is fully lowered, or as small as about 15°, when the jaw 14″ is fully raised. The proximal face 40 can, for example, be approximately perpendicular or inclined slightly distally from perpendicular to the point and base lines 42, 44. A tooth height h of the teeth 18″, measured perpendicularly from the base line 44 to the point line 42, can, for example, be about 0.1 to 0.15 inch, or more particularly approximately 0.125 inch, and a length l of the distal face 38 can be about 0.4 inch to about 0.6 inch, or approximately 0.482 inch.

A height of a lower-distal end of the ramp portion 37 is preferably adapted and configured to fit within a typical vertical clearance between a door underside and a floor surface disposed beneath the door underside where the door is installed. More particularly, the distal end of the ramp portion 37 is adapted and configured to be disposed about 0.25-0.35 inch above a floor surface F, or more particularly approximately 0.3 inch, when the doorstop 10″ is supported thereon as shown in FIG. 9. The base teeth 20″ of the floor gripping region 19″ can, for example, have an approximately equilateral triangular shape and be arranged side-by-side with an axis of each tooth 20″ pointing straight down when the doorstop 10″ is supported horizontally on its base 12″, the base teeth 20″ having a base-line-to-point-line height similar to that of the jaw teeth 18″, such as from about 1/16 inch to about ¼ inch. A height of an upper-proximal end of the ramp portion 37 is preferably adapted and configured to exceed that of a typical door underside above a floor surface where the door is installed, the tips of the jaw teeth 18″ of the door gripping region 17″ being disposed just below the profile of the ramp portion 37 when the jaw 14″ is in its fully lowered position. More particularly, the ramp portion 37 and the door gripping region 17″ of the fully lowered jaw 14″ can extend in the proximal direction up to a height, for example, of about 1-1½ inch, or more particularly about 1⅓ inch above the supporting floor surface F, approximately at a longitudinal position of the pivotal joint 15″.

Doorstops according to this disclosure, including the doorstops 10, 10′, 10″ of the above-described embodiments, can be made of any suitable materials with desirable strength and toughness properties. For example, the plates of the bases 12, 12′, 12″, jaws 14, 14′, 14″, the guide plates 26, 26′, 26″ can be made of a suitable material, including a suitable metallic material, such as being cut from ⅛-inch to ½-inch thick steel plates, or more particularly from ¼-inch thick steel plates. Alternatively, the base could be made from stainless steel, aluminum, carbon fiber, or a different suitable material. The actuator screws 22, 22′, 22″ can, for example, be stainless steel, aluminum, or a different suitable material, such as a suitable metallic material. The tabbed threaded collar 24 of the doorstop 10 and the handwheels 24′, 24″ of the doorstops 10′, 10″ can be made, for example, of cast aluminum, stainless steel, carbon fiber, or an alternative material.

According to a method of use, the doorstop 10″ is positioned with the ramp portion 37 positioned under the underside of a door, as illustrated in FIG. 9. More particularly, the doorstop 10″ can be pushed forward (i.e., in the distal direction) under the door until the ramp portion 37 abuts against the door underside, to facilitate a desired alignment of the doorstop 10″ for secure engagement with the door. More particularly, abutting the ramp portion 37 against the door underside before tightening the jaw 14″ promotes generally perpendicular alignment of the doorstop 10″ with the door, as well as insertion of the doorstop 10″ to a desired distal depth, so that a desired point or desired area of the door gripping region 17″ can engage the door when the jaw 14″ is tightened. The handwheel 24″ is then rotated so as to be driven downward on the screw 22″ (more particularly clockwise about the screw axis), in turn pressing the guide plate 26″ at the proximal end of the jaw 14″ downward, and thus pivoting the portion of the jaw 14″ disposed distally of the pivotal joint 15″ upward, until the teeth 18″ of the door gripping region 17″ press upward against the underside of the door, and the teeth 20″ of the floor gripping region 19″ press downwardly against the floor surface F, so as to resist sliding movement of the doorstop 10″ relative to the floor surface F and door opening movement of the door relative to the doorstop 10″.

The preceding description of the disclosure has been presented for purposes of illustration and description and is not intended to be exhaustive or to limit the disclosure to the precise form disclosed. The description was selected to best explain the principles of the present teachings and the practical application of these principles to enable others skilled in the art to best utilize the disclosure in various embodiments and various modifications as are suited to the particular use contemplated. It should be recognized that the words “a” or “an” are intended to include both the singular and the plural. Conversely, any reference to plural elements shall, where appropriate, include the singular.

It is intended that the scope of the disclosure not be limited by the specification but be defined by the claim(s) set forth below. In addition, although narrow claims may be presented below, it should be recognized that the scope of this disclosure is much broader than presented by the claim(s). It is intended that broader claims will be submitted in one or more applications that claim the benefit of priority from this application. Insofar as the description above and the accompanying drawings disclose additional subject matter that is not within the scope of the claim or claims below, the additional disclosures are not dedicated to the public and the right to file one or ore applications to claim such additional disclosures is reserved.

What is claimed is:

1. A security doorstop comprising
a base, the base having a lower side with a downward facing floor gripping region;
a jaw pivotally connected to the base, the jaw having an upward facing door gripping region above the downward facing floor gripping region;
an actuator, the actuator connected between the base and the jaw so that, when the door gripping region and the floor gripping region are positioned in a vertical gap between an underside of a door and a floor surface, actuating the actuator causes the door gripping region of the jaw to pivot upwardly relative to the floor gripping region of the base, to cause the door gripping region to press upwardly against the door underside and the floor gripping region to press downwardly against the floor surface.

2. The security doorstop of claim 1 further comprising the base including a plurality of downward facing base teeth in the floor gripping region.

3. The security doorstop of claim 1 further comprising the jaw including a plurality of upward facing jaw teeth in the door gripping region.

4. The security doorstop of claim 1 wherein the floor gripping region comprises all of the lower side of the base.

5. The security doorstop of claim 2, further comprising the base teeth being distributed along an entire length of the lower side of the base.

6. The security doorstop of claim 1 further comprising the jaw including a normal obstruction, the normal obstruction comprising an upward protrusion disposed proximally of the door gripping region, the normal obstruction being adapted and configured such that, when an underside of a door is gripped by the door gripping region, the door underside having a leading edge with respect to door-opening movement, the door having a vertical leading side that extends upwardly from the door underside leading edge, the normal obstruction extends above the door underside leading edge so as to oppose the vertical leading side of the door and to be operative to normally obstruct door-opening movement of the vertical leading side.

7. A method of securing a closed door using a security doorstop, the security doorstop including a base with a downward facing lower-side floor gripping region, a jaw with an upward facing door gripping region above the downward facing floor gripping region of the base, the jaw being pivotally connected to the base by a pivotal joint, and an actuator connected between the base and the jaw, the method comprising:
positioning the door gripping region of the jaw and the floor gripping region of the base in a vertical gap between an underside of a door and floor surface;
actuating the actuator to cause the door gripping region of the jaw to pivot upwardly relative to the floor gripping region of the base, to cause the door gripping region to press upwardly against the door underside and the floor gripping region to press downwardly against the floor surface.

8. The method of claim 7 wherein the doorstop has a distal end, a distal region extending distally from the pivotal joint to the distal end, a proximal end, and a proximal region extending proximally from the pivotal joint, the actuator being disposed in the proximal region, the base having a proximally upwardly inclined ramp portion in the distal region, further comprising:
before so actuating the actuator, distally inserting the distal end of the doorstop into said vertical gap until the base ramp portion abuts the door underside, with a vertical clearance present between the jaw door gripping region and the door underside.
